(19) United States
(12) Patent Application Publication
(10) Pub. No.: US 2025/0348693 A1
(43) Pub. Date: Nov. 13, 2025

(54) METHOD AND APPARATUS FOR RECEIVING SIGNAL IN COMMUNICATION SYSTEM

(71) Applicant: ELECTRONICS AND TELECOMMUNICATIONS RESEARCH INSTITUTE, Daejeon (KR)

(72) Inventors: Hoiyoon JUNG, Daejeon (KR); Ji Hyung KIM, Daejeon (KR); Cheulsoon KIM, Daejeon (KR); Sung-Hyun MOON, Daejeon (KR); Junghoon LEE, Daejeon (KR)

(73) Assignee: ELECTRONICS AND TELECOMMUNICATIONS RESEARCH INSTITUTE, Daejeon (KR)

(21) Appl. No.: 19/204,030

(22) Filed: May 9, 2025

(30) Foreign Application Priority Data
May 10, 2024 (KR) 10-2024-0062205
Jul. 10, 2024 (KR) 10-2024-0091287
Sep. 27, 2024 (KR) 10-2024-0131376
Nov. 5, 2024 (KR) 10-2024-0155143
Feb. 4, 2025 (KR) 10-2025-0014071
Mar. 24, 2025 (KR) 10-2025-0037489
Apr. 16, 2025 (KR) 10-2025-0049460
May 8, 2025 (KR) 10-2025-0059871

(51) Int. Cl. G06K 7/016; G06K 7/10; H04L 5/00; H04L 27/02

(52) U.S. Cl. CPC G06K 7/016; G06K 7/10029; G06K 7/10297; H04L 5/0007; H04L 27/02

(57) ABSTRACT

A method of a reader may comprise: generating a physical reader-to-device channel (PRDCH) preamble including a first preamble and a second preamble; generating a reader-to-device (R2D) signal including the PRDCH preamble and a PRDCH; and transmitting the R2D signal to a device, wherein the PRDCH preamble is located before the PRDCH in time domain.

### CROSS-REFERENCE TO RELATED APPLICATIONS

This application claims priority to Korean Patent Applications No. 10-2024-0062205, filed on May 10, 2024, No. 10-2024-0091287, filed on Jul. 10, 2024, No. 10-2024-0131376, filed on Sep. 27, 2024, No. 10-2024-0155143, filed on Nov. 5, 2024, No. 10-2025-0014071, filed on Feb. 4, 2025, No. 10-2025-0037489, filed on Mar. 24, 2025, No. 10-2025-0049460, filed on Apr. 16, 2025, and No. 10-2025-0059871, filed on May 8, 2025, with the Korean Intellectual Property Office (KIPO), the entire contents of which are hereby incorporated by reference.

### BACKGROUND

### 1. Technical Field

The present disclosure relates to a signal reception technique in a communication system, and more particularly, to a technique for a device to receive signals from a base station or a terminal.

### 2. Related Art

With advancements of information and communication technology, various wireless communication technologies are being developed. The representative wireless communication technologies may be long term evolution (LTE), LTE-advanced (LTE-A), new radio (NR), and the like specified as the 3^{rd} generation partnership project (3GPP) standards. The LTE and/or LTE-A may be 4^{th} generation (4G) communication technology. The NR may be a 5^{th} generation (5G) communication technology.

The 5G communication system (e.g., communication system supporting the NR) using a higher frequency band (e.g., a frequency band of 6 GHz or above) than a frequency band (e.g., a frequency band of 6 GHz or below) of the 4G communication system has been considered for processing of soaring wireless data after commercialization of the 4G communication system (e.g., communication system supporting the LTE and/or LTE-A). The 5G communication system may support enhanced Mobile BroadBand (eMBB), Ultra Reliable Low Latency Communication (URLLC), and/or Massive Machine Type Communication (mMTC).

In a communication system (e.g., 5G communication system, 6G communication system, etc.), an Internet of Things (IoT) communication scheme may be supported to accommodate a plurality of IoT devices. The IoT devices may perform communication with a base station and/or a terminal in the communication system using the IoT communication scheme. In consideration of factors such as power consumption, the IoT devices may be configured in a form having very low complexity. Accordingly, there is a need for a method of configuring and/or transmitting signals receivable by the IoT devices in the communication system, as well as a method by which the IoT devices receive such signals.

Meanwhile, the above-described technologies are described to enhance the understanding of the background of the present disclosure, and they may include non-prior arts that are not already known to those of ordinary skill in the art.

### SUMMARY

The present disclosure for resolving the above-described problems is directed to providing a signal reception method and apparatus for a device in a communication system.

A method of a reader, according to exemplary embodiments of the present disclosure, may comprise: generating a physical reader-to-device channel (PRDCH) preamble including a first preamble and a second preamble; generating a reader-to-device (R2D) signal including the PRDCH preamble and a PRDCH; and transmitting the R2D signal to a device, wherein the PRDCH preamble may be located before the PRDCH in time domain.

The first preamble may be used to indicate a transmission start of the PRDCH, and a length of the first preamble may have a fixed value in time domain.

The second preamble may be used to acquire synchronization for receiving the PRDCH, and a length of the second preamble in time domain may be changed based on M of an on-off keying (OOK) modulation scheme used for the PRDCH, and M may be a number of coded bits per orthogonal frequency division multiplexing (OFDM) symbol.

A chip period of the second preamble may be equal to a chip period of the PRDCH.

The PRDCH may include control information and a payload, and the control information may include at least one of PRDCH scheduling information or physical device-to-reader channel (PDRCH) scheduling information.

A part of the PRDCH scheduling information may be transmitted using a physical layer message.

A part of the PDRCH scheduling information may be transmitted using a higher layer message.

A cyclic redundancy check (CRC) may be applied independently for each of the control information and the payload.

A method of a device, according to exemplary embodiments of the present disclosure, may comprise: receiving a reader-to-device (R2D) signal from a reader, wherein the R2D signal may include a physical reader-to-device channel (PRDCH) preamble and a PRDCH, the PRDCH preamble may include a first preamble and a second preamble, and the PRDCH preamble may be located before the PRDCH in time domain.

The receiving of the R2D signal from the reader may comprise: determining a start time of the PRDCH based on the first preamble included in the R2D signal, wherein a length of the first preamble may have a fixed value in time domain.

The receiving of the R2D signal from the reader may comprise: acquiring synchronization for receiving the PRDCH based on the second preamble included in the R2D signal, wherein a length of the second preamble in time domain may be changed based on M of an on-off keying (OOK) modulation scheme used for the PRDCH, and M may be a number of coded bits per orthogonal frequency division multiplexing (OFDM) symbol.

A chip period of the second preamble may be equal to a chip period of the PRDCH.

The PRDCH may include control information and a payload, and the control information may include at least one of PRDCH scheduling information or physical device-to-reader channel (PDRCH) scheduling information.

A part of the PRDCH scheduling information may be received using a physical layer message.

A part of the PDRCH scheduling information may be received using a higher layer message.

A cyclic redundancy check (CRC) may be applied independently for each of the control information and the payload.

A device according to exemplary embodiments of the present disclosure may comprise at least one processor, wherein the at least one processor may cause the device to perform: receiving a reader-to-device (R2D) signal from a reader, wherein the R2D signal may include a physical reader-to-device channel (PRDCH) preamble and a PRDCH, the PRDCH preamble may include a first preamble and a second preamble, and the PRDCH preamble may be located before the PRDCH in time domain.

In the receiving of the R2D signal from the reader, the at least one processor may cause the device to perform: determining a start time of the PRDCH based on the first preamble included in the R2D signal, wherein a length of the first preamble may have a fixed value in time domain.

In the receiving of the R2D signal from the reader, the at least one processor may cause the device to perform: acquiring synchronization for receiving the PRDCH based on the second preamble included in the R2D signal, wherein a length of the second preamble in time domain may be changed based on M of an on-off keying (OOK) modulation scheme used for the PRDCH, and M may be a number of coded bits per orthogonal frequency division multiplexing (OFDM) symbol.

The PRDCH may include control information and a payload, and the control information may include at least one of PRDCH scheduling information or physical device-to-reader channel (PDRCH) scheduling information.

According to the present disclosure, a reader can generate a PRDCH preamble including a first preamble and a second preamble, generate an R2D signal including the PRDCH preamble and a PRDCH, and transmit the R2D signal to a device. The device can receive the R2D signal from the reader. As a result, the signal reception method of the device can be improved, and the power consumption of the device can be reduced. Accordingly, the performance of the communication system can be enhanced.

### BRIEF DESCRIPTION OF DRAWINGS

FIG. 1 is a conceptual diagram illustrating a communication network.

FIG. 2 is a block diagram illustrating a communication node constituting a communication network.

FIG. 3 is a conceptual diagram illustrating a communication network.

FIG. 4 is a conceptual diagram illustrating a communication network.

FIG. 5 is a conceptual diagram illustrating a structure of an R2D signal in a communication network.

FIG. 6 is a conceptual diagram illustrating a line code in a communication network.

FIG. 7 is a conceptual diagram illustrating a structure of a preamble (e.g., preamble signal) in a communication network.

FIG. 8 is a conceptual diagram illustrating a structure of a PRDCH in a communication network.

FIG. 9 is a conceptual diagram illustrating a PRDCH reception method in a communication network.

FIG. 10 is a flowchart illustrating a method of operation of a device in a communication network.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication network to which the exemplary embodiments according to the present disclosure are applied is not limited to the contents described below, and the exemplary embodiments according to the present disclosure may be applied to various communication networks. Here, the communication network may be used in the same sense as a communication system. A communication network may refer to a wireless communication network, and a communication system may refer to a wireless communication system.

In the present disclosure, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. In the present disclosure, signaling may be at least one of system information (SI) signaling (e.g., transmission of system information block (SIB) and/or master information block (MIB)), RRC signaling (e.g., transmission of RRC parameters and/or higher-layer parameters), MAC control element (CE) signaling, or PHY signaling (e.g., transmission of downlink control information (DCI), uplink control information (UCI), and/or sidelink control information (SCI)).

In the present disclosure, ‘time’ and ‘time point’ may be used interchangeably. The term ‘time’ may be interpreted as referring to either a time or a time point depending on a context, and the term ‘time point’ may also be interpreted as referring to either a time or a time point depending on a context.

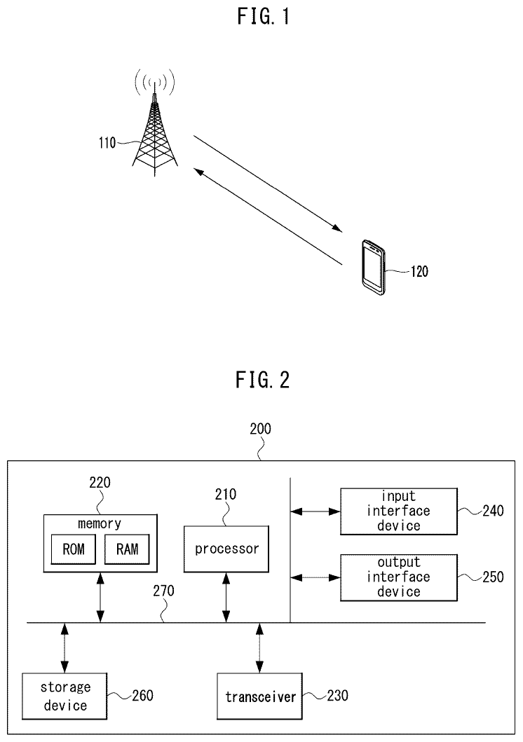

FIG. 1 is a conceptual diagram illustrating a communication network.

Referring to FIG. 1, a base station 110 may support cellular communication (e.g., long term evolution (LTE), LTE-Advanced (LTE-A), LTE-A Pro, LTE-unlicensed (LTE-U), New Radio (NR), and NR-unlicensed (NR-U) specified as the 3^{rd} generation partnership project (3GPP) standards), or the like. The base station 110 may support multiple-input multiple-output (MIMO) (e.g., single-user MIMO (SU-MIMO), multi-user MIMO (MU-MIMO), massive MIMO, etc.), coordinated multipoint (COMP), carrier aggregation (CA), or the like. The terminal 120 may perform communication (e.g., uplink communication and/or downlink communication) with the base station 110.

The communication node (i.e., base station, terminal, etc.) constituting the communication network described above may support a code division multiple access (CDMA) based communication protocol, a wideband CDMA (WCDMA) based communication protocol, a time division multiple access (TDMA) based communication protocol, a frequency division multiple access (FDMA) based communication protocol, a single carrier-FDMA (SC-FDMA) based communication protocol, an orthogonal frequency division multiplexing (OFDM) based communication protocol, an orthogonal frequency division multiple access (OFDMA) based communication protocol, or the like.

Among the communication nodes, the base station may be referred to as a Node B, evolved Node B, 5G Node B (gNodeB), base transceiver station (BTS), radio base station, radio transceiver, access point, access node, transmission/reception point (Tx/Rx Point), or the like. Among the communication nodes, the terminal may be referred to as a user equipment (UE), access terminal, mobile terminal, station, subscriber station, portable subscriber station, mobile station, node, device, or the like. The communication node may have the following structure.

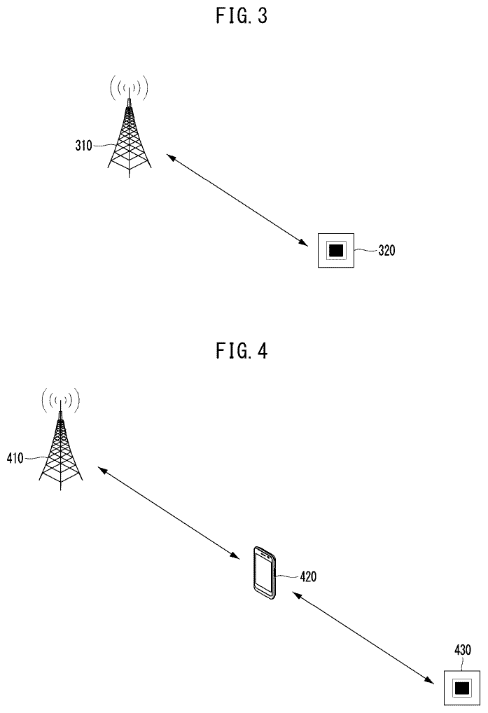

FIG. 2 is a block diagram illustrating a communication node constituting a communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

FIG. 3 is a conceptual diagram illustrating a communication network.

Referring to FIG. 3, a base station 310 may support cellular communication (e.g., 5G communication, 6G communication, etc.). The base station 310 may support IoT communication. A device 320 may support IoT communication. The device 320 may not support cellular communication. The base station 310 and the device 320 may perform communication by using an IoT communication scheme. In the present disclosure, the device may be interpreted as an IoT device depending on a context. The IoT device may perform communication by using the IoT communication scheme. In the present disclosure, the base station that performs communication with the device based on the IoT communication scheme may be interpreted as a reader.

FIG. 4 is a conceptual diagram illustrating a communication network.

Referring to FIG. 4, a base station 410 may support cellular communication. The base station 410 may support IoT communication. A terminal 420 may support cellular communication. The terminal 420 may support IoT communication. A device 430 may support IoT communication. The device 430 may not support cellular communication. The base station 410 and the terminal 420 may perform communication by using a cellular communication scheme. The terminal 420 and the device 430 may perform communication by using an IoT communication scheme. In the present disclosure, the terminal that performs communication with the device based on the IoT communication scheme may be interpreted as a reader.

Hereinafter, operation methods of a communication node (e.g., device) in a communication network will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a first terminal (e.g., transmitting terminal) is described, a corresponding second terminal (e.g., receiving terminal) may perform an operation corresponding to the operation of the first terminal. Conversely, when an operation of the second terminal is described, the corresponding first terminal may perform an operation corresponding to the operation of the second terminal. When an operation of a device (e.g., IoT device) is described, a corresponding reader (e.g., base station and/or terminal) may perform an operation corresponding to the operation of the device. Conversely, when an operation of the reader (e.g., base station and/or terminal) is described, the corresponding device may perform an operation corresponding to the operation of the reader.

For convenience of description, the base station or terminal that performs IoT communication with the device illustrated in FIG. 3 and/or FIG. 4 may be referred to as a reader. In reader-to-device (R2D) communication, the reader may transmit a signal, and the device may receive the signal from the reader. In device-to-reader (D2R) communication, the device may transmit a signal, and the reader may receive the signal from the device. An R2D communication scheme will be described. In the R2D communication scheme, the reader may transmit a signal. In the R2D communication scheme, the device may receive the signal transmitted by the reader. Among channels transmitted from the reader to the device in the R2D communication scheme, one channel may be defined as a Physical Reader-to-Device Channel (PRDCH). The reader may transmit a PRDCH to the device. The device may receive the PRDCH from the reader.

FIG. 5 is a conceptual diagram illustrating a structure of an R2D signal in a communication network.

Referring to FIG. 5, an R2D signal may include a preamble, a PRDCH, and a postamble. The reader may generate an R2D signal including at least one of the preamble, the PRDCH (e.g., PRDCH signal), or the postamble, and may transmit the R2D signal to the device. The device may receive the R2D signal from the reader. According to a configuration of the R2D signal, the postamble may not be transmitted. In other words, the R2D signal may include the preamble and the PRDCH without the postamble. The preamble may be transmitted prior to the PRDCH in the time domain. The preamble and the PRDCH may be transmitted consecutively in the time domain. In other words, the PRDCH may be transmitted without a time gap or another signal after the preamble.

The postamble may be transmitted after the PRDCH in the time domain. For example, the PRDCH and the postamble may be transmitted consecutively in the time domain. In other words, the postamble may be transmitted without a time gap or another signal after the PRDCH. In another example, a padding signal may be transmitted between the PRDCH and the postamble. The padding signal may be transmitted in a predefined form. For example, the padding signal may be a signal indicating data having a value of 0. In other words, the padding signal may be zero padding. In another example, the padding signal may be a signal having an amplitude of 0. The padding signal may be transmitted after the transmission of the PRDCH and the postamble. The padding signal may be an arbitrary signal configured according to an implementation of the reader. The padding signal may have a signal form used for R2D transmission. For example, the padding signal may be a signal generated based on a line code. In a configuration of the R2D signal, the padding signal may not be included in the R2D signal. An end time point (e.g., end time) of the R2D signal may be defined differently depending on whether a padding signal is included in the R2D signal configuration. For example, when the padding signal is not included in the R2D signal, the end time may refer to a time at which the R2D signal without the padding signal ends. Alternatively, when the padding signal is included in the R2D signal, the end time may refer to a time at which the padding signal ends.

Hereinafter, a line code will be described. A line code (e.g., line coding) may be one of signal generation schemes for expressing bit information as a waveform.

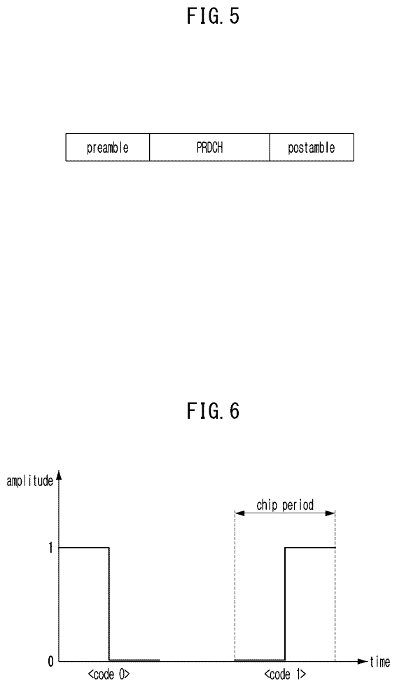

FIG. 6 is a conceptual diagram illustrating a line code in a communication network.

Referring to FIG. 6, a communication node (e.g., base station, terminal, device, or reader) in a communication network may convert bit information into a waveform by using a line code. Based on the line code, bit information ‘0’ may be converted into a form of a code 0 (e.g., line code 0). Based on the line code, bit information ‘1’ may be converted into a form of a code 1 (e.g., line code 1). A length of a time duration of one code (e.g., code 0 or code 1) may be defined as a chip period or chip duration of the line code. In the present disclosure, a chip period may refer to a chip rate. Depending on a code, one or more transitions may occur within a chip period. The transition may refer to a change in amplitude. For example, the transition may refer to a change from amplitude 0 to amplitude 1 or a change from amplitude 1 to amplitude 0.

A length of a time duration having an amplitude of 0 and a length of a time duration having an amplitude of 1 within a time duration (e.g., entire time duration) of the code 0 or code 1 may each be defined as a chip period or chip duration of the line code. One bit information may be defined as a code having a length of (chip period×2) or (chip duration×2) through the line code.

Hereinafter, the preamble in the R2D signal will be described.

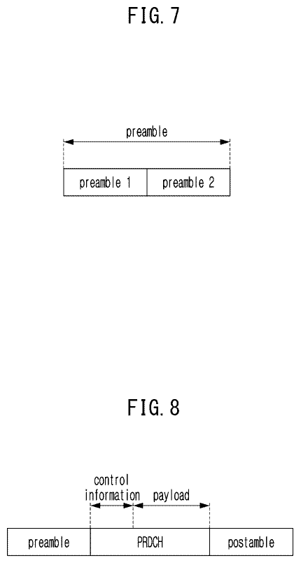

FIG. 7 is a conceptual diagram illustrating a structure of a preamble (e.g., preamble signal) in a communication network.

Referring to FIG. 7, a preamble (e.g., PRDCH preamble) used for R2D transmission may be divided into two preambles (e.g., preamble 1 and preamble 2). The reader may generate a PRDCH preamble including the preamble 1 (e.g., first preamble) and the preamble 2 (e.g., second preamble). The preamble 1 may be referred to as the first preamble or a sub-preamble 1. The preamble 2 may be referred to as the second preamble or a sub-preamble 2. The preamble 1 and the preamble 2 may be transmitted consecutively in the time domain. Signal configurations of the preamble 1 and the preamble 2 may be different from each other. The preamble 1 and the preamble 2 may be used for different purposes.

The preamble 1 may be used to indicate a start time of the R2D transmission to the device. Information on the start time of the R2D transmission may be included in the preamble 1. The device may detect the preamble 1 to identify that the R2D transmission has started. The device may detect the preamble 1 to identify information on the start time of the R2D transmission or a PRDCH transmission.

The preamble 1 may have a form in which a signal having a certain amplitude is present for a certain time duration. A length of the certain time duration may be identical to a length of a time duration of the preamble 1. The length of the time duration of the preamble 1 may be a multiple of a chip period of a line code. For example, when the chip period of the line code is T, the length of the time duration of the preamble 1 may be T, 2T, 3T, or the like. The chip period of the line code may be a chip period of a line code for the preamble 2 or the PRDCH. The amplitude of the preamble 1 may have a value greater than or equal to a specific threshold. The threshold may be a predefined value. The reader and/or the device may know the predefined threshold. As another method, the reader may transmit information on the threshold to the device through signaling. The device may receive the information on the threshold through the signaling from the reader.

The reader may generate the preamble 1 based on the line code, and a transition of amplitude may occur in the preamble 1. One code of the line code may be repeated in the preamble 1. In other words, the preamble 1 may include repeated codes. The preamble 1 may include repeated code 0 and/or repeated code 1 in the time domain.

In another example, the preamble 1 may include at least one transition (e.g., transition duration). The transition (e.g., transition duration) may be a transition (e.g., transition duration) from a signal having a low amplitude to a signal having a high amplitude or a transition (e.g., transition duration) from a signal having a high amplitude to a signal having a low amplitude. The low amplitude may correspond to an OFF amplitude in on-off keying (OOK) modulation. The high amplitude may correspond to an ON amplitude in OOK modulation. The preamble 1 may include at least one duration having an ON amplitude based on the OOK modulation and/or at least one duration having an OFF amplitude based on the OOK modulation. For example, the low amplitude may mean that a magnitude of the signal is 0. The high amplitude may mean that a magnitude of the signal is 1.

In another example, the preamble 1 may include one signal having a high amplitude and one signal having a low amplitude. The signal having a high amplitude may precede the signal having a low amplitude in the time domain. Alternatively, the signal having a low amplitude may precede the signal having a high amplitude in the time domain. A length (e.g., time duration) of the signal having a high amplitude may be the same as a length (e.g., time duration) of the signal having a low amplitude. Alternatively, the length of the signal having a high amplitude may be different from the length of the signal having a low amplitude. For example, the length of the signal having a high amplitude may be N times the length of the signal having a low amplitude. Alternatively, the length of the signal having a low amplitude may be N times the length of the signal having a high amplitude. N may be a natural number.

In another exemplary embodiment, the preamble 1 may include at least one signal having a high amplitude and at least one signal having a low amplitude. One signal set may include one signal having a high amplitude and one signal having a low amplitude. Within the one signal set, a length (e.g., time duration) of the signal having a high amplitude may be identical to a length (e.g., time duration) of the signal having a low amplitude. Alternatively, within the one signal set, the length of the signal having a high amplitude may be different from the length of the signal having a low amplitude. For example, the length of the signal having a high amplitude may be N times the length of the signal having a low amplitude. Alternatively, the length of the signal having a low amplitude may be N times the length of the signal having a high amplitude. N may be a natural number.

In another exemplary embodiment, the preamble 1 may include a signal 1 and a signal 2, each having a first section with a high amplitude and a second section with a low amplitude in the time domain. The first section of the signal 1 with the high amplitude and the first section of the signal 2 with the high amplitude may have the same length (e.g., the same time duration). The second section of the signal 1 with the low amplitude and the second section of the signal 2 with the low amplitude may have different lengths (e.g., different time durations). The first section of the signal 1 with the high amplitude and the second section of the signal 1 with the low amplitude may have the same length (e.g., the same time duration). The first section of the signal 2 with the high amplitude and the second section of the signal 2 with the low amplitude may have different lengths (e.g., different time durations). The length (e.g., time duration) of the second section of the signal 2 with the low amplitude may be N times the length (e.g., time duration) of another signal (e.g., the first section of the signal 1 with the high amplitude, the first section of the signal 2 with the high amplitude, or the second section of the signal 1 with the low amplitude). N may be a natural number. For example, N may be 3.

In another exemplary embodiment, the preamble 1 may include one or more transitions from a signal having a low amplitude to a signal having a high amplitude and/or one or more transitions from a signal having a high amplitude to a signal having a low amplitude. The preamble 1 may include two or more transitions from a signal having a low amplitude to a signal having a high amplitude and/or two or more transitions from a signal having a high amplitude to a signal having a low amplitude. Within the preamble 1 (e.g., time duration of the preamble 1), transitions from a signal having a low amplitude to a signal having a high amplitude and transitions from a signal having a high amplitude to a signal having a low amplitude may be repeated. Alternatively, within the preamble 1 (e.g., time duration of the preamble 1), transitions from a signal having a high amplitude to a signal having a low amplitude and transitions from a signal having a low amplitude to a signal having a high amplitude may be repeated.

In another exemplary embodiment, the preamble 1 may have a signal waveform (e.g., signal form) that is not generated based on a line code. In other words, the preamble 1 may have a predefined signal waveform. The reader and/or the device may know the predefined signal waveform for the preamble 1. When a line code is used, a transition from amplitude 0 to amplitude 1 or from amplitude 1 to amplitude 0 may occur within one chip period. In other words, each code may include a transition from amplitude 0 to amplitude 1 or from amplitude 1 to amplitude 0. The preamble 1 may include a signal having amplitude 0 or a signal having amplitude 1, and the preamble 1 (e.g., the signal having amplitude 0 or the signal having amplitude 1) may be transmitted for a time duration longer than one chip period.

In another exemplary embodiment, a signal having a high amplitude and a signal having a low amplitude included in the preamble 1 may be determined based on a sequence. The sequence may be a binary sequence. In the sequence, ‘1’ may be mapped to a signal having a high amplitude. In the sequence, ‘0’ may be mapped to a signal having a low amplitude. A signal having a high amplitude based on the predefined sequence and a signal having a low amplitude based on the predefined sequence may be present within the preamble 1.

The length of the time duration of the preamble 1 may be a fixed length regardless of a modulation scheme and/or a chip period used for R2D transmission. For example, the length of the time duration of the preamble 1 may correspond to a length of one OFDM symbol. Alternatively, the length of the time duration of the preamble 1 may be a half of the length of one OFDM symbol. The length of the OFDM symbol may be a length of an OFDM symbol based on a 15 kHz subcarrier spacing defined in the 5G technical specifications (e.g., NR technical specifications). In another example, the length of the time duration of the preamble 1 may be equal to one chip period for OOK-4 (M=1) modulation. Alternatively, the length of the time duration of the preamble 1 may be equal to two chip durations for OOK-4 (M=2) modulation. M may indicate the number of coded bits per OFDM symbol.

In another exemplary embodiment, the length of the time duration of the preamble 1 may vary depending on the modulation scheme and/or the chip period used for R2D transmission. For example, the length of the time duration of the preamble 1 may vary depending on a value of M in the OOK-4 (M) modulation scheme used for R2D transmission. M may be a natural number. As the value of M increases, the length of the preamble 1 may decrease. Alternatively, as the value of M increases, the length of the preamble 1 may increase. The length of the time duration of the preamble 1 may vary depending on the chip period used for R2D transmission. As the chip period used for R2D transmission increases, the length of the preamble 1 may increase. Alternatively, as the chip period used for R2D transmission increases, the length of the preamble 1 may decrease. The preamble 2 may be located after the end of the preamble 1 in the time domain. The preamble 2 may be transmitted consecutively with the preamble 1 in the time domain. In other words, the preamble 1 and the preamble 2 may be consecutive in the time domain, and there may be no separate time gap between the preamble 1 and the preamble 2.

A signal amplitude at an end time point (e.g., end time) of the preamble 1 may be different from a signal amplitude at a start time point (e.g., start time) of the preamble 2. For example, at the end time of the preamble 1, a signal may have a low amplitude, and at the start time of the preamble 2, a signal may have a high amplitude. In another example, at the end time of the preamble 1, a signal may have a high amplitude, and at the start time of the preamble 2, a signal may have a low amplitude.

The preamble 2 may be used for synchronization acquisition (e.g., time synchronization acquisition) at the device. The device may acquire time synchronization for PRDCH reception by using the preamble 2. The preamble 2 may include additional information for PRDCH reception. The preamble 2 may include OOK modulation information (e.g., information on a length of a time duration of an OOK modulation symbol). For example, the preamble 2 may indicate (e.g., include) information on a value of M for the OOK-4 (M) modulation scheme. The value of M for the OOK-4 (M) modulation scheme may indicate an amount of information indicatable through an ON or OFF duration within a predefined time duration. For example, in a case of OOK-4 (M=4), four durations may exist within a predefined time duration, and each of the four durations may be an ON duration or an OFF duration.

Depending on a system configuration (e.g., configuration of the communication system), the predefined time duration may correspond to one OFDM symbol. The device may receive the preamble 2 and may identify information on the length of the time duration of one symbol for the OOK modulation scheme based on the information included in the preamble 2. The device may receive the preamble 2 and may identify information on the value of M for the OOK-4 (M) modulation scheme based on the information included in the preamble 2. In another example, the preamble 2 may indicate (e.g., include) information on a chip period of a line code used for PRDCH configuration. The device may receive the preamble 2 and may identify information on the chip period of the line code used for PRDCH transmission based on the information included in the preamble 2.

The reader may generate (e.g., configure) the preamble 2 based on the line code. The line code may be used for configuration and/or transmission of the PRDCH (e.g., PRDCH signal). The device may identify information on the chip period of the line code applied to the PRDCH based on the chip period of the line code used for the preamble 2. For example, the reader may generate the preamble 2 and the PRDCH having the same chip period of the line code and may transmit the preamble 2 and the PRDCH to the device. In other words, the chip period of the line code for the preamble 2 may be identical to the chip period of the line code for the PRDCH. The device may determine that the chip period of the line code for the preamble 2 is identical to the chip period of the line code for the PRDCH and may receive the PRDCH (e.g., PRDCH signal) based on the same chip period as the preamble 2.

One ON duration (e.g., a length of one ON signal) for the preamble 2 may be identical to one ON duration (e.g., a length of one ON signal) for the PRDCH. The device may determine that one ON duration for the preamble 2 is identical to one ON duration for the PRDCH. One OFF duration (e.g., a length of one OFF signal) for the preamble 2 may be identical to one OFF duration (e.g., a length of one OFF signal) for the PRDCH. The device may determine that one OFF duration for the preamble 2 is identical to one OFF duration for the PRDCH. The device may receive the preamble 2, identify the length of one duration (e.g., ON duration, ON signal duration, OFF duration, OFF signal duration), and may receive the PRDCH (e.g., PRDCH signal) based on the identified length.

The preamble 2 may be configured based on a combination of consecutive line codes. For example, the preamble 2 may include consecutive instances of line code 0 (e.g., code 0 of the line code) in the time domain. In another example, the preamble 2 may include consecutive instances of line code 1 (e.g., code 1 of the line code) in the time domain.

In another exemplary embodiment, the code 0 and code 1 of the line code in the preamble 2 may exist sequentially. The code 0 may be the same as or similar to the code 0 in the exemplary embodiment of FIG. 6. The code 1 may be the same as or similar to the code 1 in the exemplary embodiment of FIG. 6. One code (e.g., code 0 or code 1) of the line code may be a code including a transition from amplitude 0 to amplitude 1 or a transition from amplitude 1 to amplitude 0 within a chip period.

The preamble 2 may include two or more transitions. The transition may be a transition from amplitude 0 to amplitude 1 or a transition from amplitude 1 to amplitude 0. A signal having amplitude 0 may indicate a signal with relatively low amplitude. A signal having amplitude 1 may indicate a signal with relatively high amplitude. In another example, the preamble 2 may include two or more transitions from amplitude 0 to amplitude 1 and/or two or more transitions from amplitude 1 to amplitude 0. The device may measure a time interval between identical transitions and may determine a chip period based on the measured time interval.

For example, the device may measure a time interval (e.g., time difference) between a first transition time from amplitude 0 to amplitude 1 and a second transition time from amplitude 0 to amplitude 1, and may determine the time interval (e.g., time difference) as a chip period. In another example, the device may measure a time interval (e.g., time difference) between a first transition time from amplitude 1 to amplitude 0 and a second transition time from amplitude 1 to amplitude 0, and may determine the time interval (e.g., time difference) as a chip period. The chip period may be a time duration corresponding to one symbol (e.g., one time duration) for OOK modulation or one code in the line code for the PRDCH.

The preamble 2 may include a signal having amplitude 1, a signal having amplitude 0, a signal having amplitude 1, and a signal having amplitude 0. Alternatively, the preamble 2 may include a signal having amplitude 1, a signal having amplitude 0, and a signal having amplitude 1.

The measured chip period (e.g., the chip period measured by the device) may be a multiple of the chip period of the line code used for PRDCH transmission. When the chip period for the preamble 2 (e.g., preamble 2 signal) is T, the chip period of the line code used for PRDCH transmission may be T, 2T, 3T, or the like. In another example, when the chip period for the preamble 2 (e.g., preamble 2 signal) is T, the chip period of the line code used for PRDCH transmission may be T, 1/2T, 1/3T, or the like.

The length of the time duration of the preamble 2 may be variable depending on information indicated by the preamble 2. For example, the length of the time duration of the preamble 2 may vary depending on the value of M for the OOK-4 (M) modulation scheme indicated by the preamble 2. The length of the time duration of the preamble 2 may decrease as the value of M for the OOK-4 (M) modulation scheme used for PRDCH transmission increases. The length of the time duration of the preamble 2 may increase as the value of M for the OOK-4 (M) modulation scheme used for PRDCH transmission decreases. The length of the time duration of the preamble 2 may be inversely proportional to the value of M for the OOK-4 (M) modulation scheme used for PRDCH transmission. In R2D transmission, the chip period T of the R2D signal or the length T of one OOK symbol for PRDCH transmission may be defined as shown in Equation 1.

$$T = ( \frac{1}{subcarrier spacing} ) / M \qquad [ Equation 1 ]$$

In Equation 1, the subcarrier spacing may be 15 kHz. In Equation 1, M may indicate the value of M for the OOK-4 (M) modulation scheme used for PRDCH transmission. A maximum value of T may be defined using Equation 1 with respect to a minimum M value of the OOK-4 (M) modulation scheme supported by the system (e.g., communication system).

The preamble 2 may be configured in an ON-OFF-ON-OFF pattern. ‘ON’ may indicate an ON signal or an ON duration. ‘OFF’ may indicate an OFF signal or an OFF duration. In the ON-OFF-ON-OFF pattern for the preamble 2, a length of one ON signal or a length of one OFF signal may vary depending on the value of M for the OOK-4 (M) modulation scheme. For example, for the OOK-4 (M=1) modulation scheme, a length of one ON signal or a length of one OFF signal may be T. In the above case, a total time length of the preamble 2 may be 4T. In another example, for the OOK-4 (M=4) modulation scheme, a length of one ON signal or a length of one OFF signal may be T/4. In the above case, a total time length of the preamble 2 may be T. The length of the time duration of the preamble 2 may vary depending on the value of M for the OOK-4 (M) modulation scheme indicated by the preamble 2. The length of the time duration of the preamble 2 may be inversely proportional to the value of M for the OOK-4 (M) modulation scheme indicated by the preamble 2.

In another exemplary embodiment, the length of the time duration of the preamble 2 may be fixed regardless of the information indicated by the preamble 2. The length of the time duration of the preamble 2 may be defined using Equation 1 with respect to a minimum M value of the OOK-4 (M) modulation scheme supported by the system.

The preamble 2 may be configured in an ON-OFF-ON-OFF pattern. For example, for the OOK-4 (M=1) modulation scheme, a length of one ON signal or one OFF signal may be T. In the above case, a time length of the preamble 2 may be 4T. In another example, for the OOK-4 (M=4) modulation scheme, a length of one ON signal or one OFF signal may be T/4. For the OOK-4 (M=4) modulation scheme, a length of a time duration of the ON-OFF-ON-OFF pattern may be T.

In order to set the length of the time duration of the preamble 2 to be the same regardless of the value of M for the OOK-4 (M) modulation scheme, the ON-OFF-ON-OFF pattern may be repeated four times for the OOK-4 (M=4) modulation scheme. In this case, the length of the time duration of the preamble 2 may become 4T. In the preamble 2, a length of one ON signal or one OFF signal for the OOK-4 (M=K2) modulation scheme may be K1/K2 times the length of one ON signal or one OFF signal for the OOK-4 (M=K1) modulation scheme. In the preamble 2, a pattern based on the OOK-4 (M=K1) modulation scheme may be repeated K2/K1 times. In the preamble 2, a length of one ON signal or one OFF signal for the OOK-4 (M=2) modulation scheme may be half a length of one ON signal or one OFF signal for the OOK-4 (M=1) modulation scheme. In the preamble 2, the pattern based on the OOK-4 (M=1) modulation scheme may be repeated two times.

The length of the time duration of the preamble (e.g., PRDCH preamble) including the preamble 1 and the preamble 2 may be fixed. For example, the length of the time duration of the PRDCH preamble may be identical to a length of N OFDM symbols in the communication system (e.g., NR system). N may be a natural number. The time duration of the PRDCH preamble may not include a cyclic prefix (CP). Alternatively, the time duration of the PRDCH preamble may include a CP.

In a configuration of the PRDCH preamble, the length of the time duration of the preamble 1 and the length of the time duration of the preamble 2 may be predefined. The predefined time duration may be a fixed length. The length of the time duration of each of the preamble 1 and the preamble 2 may be predefined, and a chip period for configuring the preamble may vary depending on a system configuration. A period of transitions existing within the preamble 1 and/or the preamble 2 may vary depending on a system configuration.

In a configuration of the PRDCH preamble, the length of the time duration of the preamble 1 may be fixed, and the length of the time duration of the preamble 1 may be predefined. The predefined time duration may be a fixed length. In a configuration of the PRDCH preamble, the length of the time duration of the preamble 2 may be variable. The length of the time duration of the preamble 2 may vary depending on a system configuration. The length of the time duration of the preamble 2 may vary depending on the value of M for the OOK-4 (M) modulation scheme used for PRDCH transmission.

A PRDCH configuration method will be described. The PRDCH may be transmitted after the preamble in the time domain. The PRDCH may be transmitted consecutively with the preamble in the time domain. An OOK modulation scheme may be used as a modulation scheme for the PRDCH. A line code may be applied in the configuration of the PRDCH. A Manchester code may be applied as the line code. The Manchester code may be one of the types of line codes. The configuration of the Manchester code may be identical or similar to the exemplary embodiment of FIG. 6. The PRDCH may be transmitted before the postamble in the time domain. The PRDCH may be transmitted consecutively with the postamble in the time domain. Padding bits may be transmitted between the PRDCH and the postamble. Alternatively, padding bits may be transmitted after the transmission of the PRDCH and the postamble. The postamble may not be transmitted depending on a system configuration.

Hereinafter, a structure of the PRDCH will be described.

FIG. 8 is a conceptual diagram illustrating a structure of a PRDCH in a communication network.

Referring to FIG. 8, a PRDCH may include control information and a payload. The control information may include PRDCH scheduling information and/or scheduling information of a physical device-to-reader channel (PDRCH) transmission scheduled by the PRDCH. The scheduling information of the PDRCH transmission may be referred to as PDRCH scheduling information. The control information of the PRDCH may start from a start time of the PRDCH in the time domain. In other words, the control information of the PRDCH may exist consecutively after the preamble. The payload of the PRDCH may be configured after the control information. The control information of the PRDCH may be referred to as PRDCH control information. The payload of the PRDCH may be referred to as a PRDCH payload. The PRDCH payload may mean PRDCH data.

The PRDCH control information may be transmitted through a higher layer message (e.g., RRC message, MAC CE). When the PRDCH control information is transmitted through a higher layer message, the PRDCH may include only the PRDCH payload (e.g., PRDCH data).

The PRDCH control information may be transmitted separately from the PRDCH data. The PRDCH control information and the PRDCH data may have different PRDCH forms (e.g., different PRDCH formats). The PRDCH control information may be transmitted through a physical layer message (e.g., L1 control information, DCI).

In the transmission of the PRDCH control information, the PRDCH scheduling information and the PDRCH scheduling information may be transmitted in different manners. A part of the PRDCH scheduling information may be transmitted through a physical layer message (e.g., L1 control information, DCI), and the remaining part of the PRDCH scheduling information may be included in an R2D signal (e.g., PRDCH). A part of the PRDCH scheduling information may be transmitted by being time division multiplexed with the PRDCH payload in a physical layer message. A part of the PRDCH scheduling information may be transmitted through a higher layer message. A part of the PDRCH scheduling information may be transmitted through a physical layer message. A part of the PDRCH scheduling information may be transmitted through a higher layer message.

A certain part of scheduling information may be information commonly applied to both PRDCH scheduling and PDRCH scheduling. For example, information on an identifier (ID) of the device receiving the PRDCH and information on an ID of the device receiving the PDRCH scheduling information may be information commonly applied to PRDCH scheduling and PDRCH scheduling. The ID information may be included in the PRDCH scheduling information and/or the PDRCH scheduling information, and the ID information may be used for PRDCH scheduling and PDRCH scheduling. For example, the ID information may be included in the PRDCH scheduling information, and the ID information included in the PRDCH scheduling information may be used for PRDCH scheduling and PDRCH scheduling. The ID information may be transmitted through a physical layer message. Alternatively, the ID information may be transmitted through a higher layer message.

A Cyclic Redundancy Check (CRC) may be applied to the PRDCH control information and the PRDCH data. The PRDCH control information may include a part of the PRDCH scheduling information or the PDRCH scheduling information. Separate CRC bits may be used (e.g., applied) for the PRDCH control information and the PRDCH data. Different CRC bits may be applied to the PRDCH control information. Different-length CRC bits or identical-length CRC bits may be used for the PRDCH control information and the PRDCH data. Different CRC bit generation methods or identical CRC bit generation methods may be used for the PRDCH control information and the PRDCH data. A CRC operation for the PRDCH control information may be performed independently of a CRC operation for the PRDCH data. In another exemplary embodiment, the two pieces of information or data—the PRDCH control information and the PRDCH data—may be concatenated, and a single CRC may be applied to the resulting combined block.

The PRDCH scheduling information of the PRDCH control information will be described. The PRDCH control information (e.g., PRDCH scheduling information) may include time resource information (e.g., time duration length information) for the PRDCH transmission. In the present disclosure, the PRDCH control information may be interpreted as PRDCH scheduling information depending on a context. The length of the time duration of the PRDCH transmission may be indicated by a number of chips of the line code used for PRDCH transmission. The number of chips may be a number of chips based on a transition period or chip period used for transmission of the preamble 2. Alternatively, the number of chips may be a number of chips based on a chip period used for transmission of the PRDCH data.

In another exemplary embodiment, the length of the time duration of the PRDCH transmission may be indicated by a size of a Transport Block (TB) for the PRDCH. The size of the TB may be indicated in bytes. The size of the TB may be indicated by bit information. A length of the bit information indicating the TB size may be 7 bits. In another exemplary embodiment, the length of the time duration of the PRDCH transmission may be indicated as the number of bits constituting the PRDCH.

The device may identify the length of the time duration of the PRDCH by using one or more of the above-described pieces of information. The device may identify an end time point (e.g., end time) of the PRDCH transmission by using one or more of the above-described pieces of information.

The device may receive the PRDCH control information from the reader and may identify one or more pieces of information (e.g., the above-described information) included in the PRDCH control information. The device may identify the PRDCH configuration information based on the preamble received before the PRDCH. The device may identify information on the length of the time duration of the PRDCH based on the information received through the preamble and/or the PRDCH control information. For example, the device may identify the chip period of the PRDCH based on the preamble, may identify the number of chips of the PRDCH based on the PRDCH control information, and may identify the length of the time duration of the PRDCH based on the chip period and the number of chips. In another example, the device may identify the chip period of the PRDCH based on the preamble, may identify the TB size based on the PRDCH control information, and may identify the length of the time duration of the PRDCH based on the chip period and the TB size. The device may identify the length of the time duration of the PRDCH by using the above-described information. The device may identify an end time of the PRDCH transmission by using the above-described information.

In another exemplary embodiment, the PRDCH control information may include at least one of the chip period used for PRDCH transmission, the TB size for the PRDCH, the number of bits of the PRDCH, or the number of chips of the PRDCH. The device may identify a PRDCH configuration based on the PRDCH control information received from the reader, and may identify the length of the time duration of the PRDCH and/or the end time of the PRDCH transmission based on the PRDCH configuration.

The PRDCH scheduling information of the PRDCH control information may include information on the device that receives the PRDCH transmission. The information on the device receiving the PRDCH transmission may include at least one of a device ID or a device group ID. A device group may include one or more devices. The device ID included in the PRDCH scheduling information may indicate the device that receives the PRDCH transmitted based on the PRDCH scheduling information. The device group ID included in the PRDCH scheduling information may indicate a device group that includes the device receiving the PRDCH transmitted based on the PRDCH scheduling information.

When the PRDCH control information (e.g., PRDCH scheduling information) includes ID information (e.g., a device ID and/or a device group ID), the device may determine whether to receive the PRDCH (e.g., the PRDCH payload, the PRDCH data) based on the device ID and/or the device group ID. When the ID of the device matches the device ID or the device group ID included in the PRDCH control information, the device may perform a reception operation for the PRDCH (e.g., the PRDCH payload, the PRDCH data). When the ID of the device does not match the device ID or the device group ID included in the PRDCH control information, the device may not perform a reception operation for the PRDCH (e.g., the PRDCH payload, the PRDCH data).

The PRDCH scheduling information of the PRDCH control information may include information on the reader (e.g., base station or terminal) that performs the PRDCH transmission. The information on the reader performing the PRDCH transmission may include information on a reader ID.

The PRDCH scheduling information of the PRDCH control information may include cast type information of the PRDCH transmission. The cast type information may indicate at least one of unicast, multicast, or broadcast. When the cast type information indicates unicast, the PRDCH transmission may be performed in a unicast manner. When the cast type information indicates multicast, the PRDCH transmission may be performed in a multicast manner. When the cast type information indicates broadcast, the PRDCH transmission may be performed in a broadcast manner.

The PRDCH scheduling information of the PRDCH control information may include content related to an action indicated by the PRDCH to the device. A type of the action indicated by the PRDCH to the device may be one of ‘inventory’ or ‘command’. The device may perform an operation corresponding to the PRDCH reception based on the above-described information and may transmit a result of the operation to the reader. The device may identify length information of the PRDCH transmission according to the indication of the type of the action. For example, the length (e.g., time duration) of the PRDCH transmission depending on a message type (e.g., type of the action) may be predefined, and the device may identify the length (e.g., time duration) of the PRDCH transmission based on the indicated message type (e.g., type of the action).

The PRDCH scheduling information of the PRDCH control information may include message type information of the PRDCH. For example, the message type of the PRDCH may include at least one of paging, a response to PDRCH transmission, or a hybrid automatic repeat request (HARQ) response (e.g., ACK or NACK) to PDRCH transmission.

The PRDCH scheduling information of the PRDCH control information may include an indication of a message type of the PRDCH. The message type may include at least one of R2D data, D2R data, control information, broadcast information, random access trigger, or random access message 2 (e.g., RA Msg2).

The PRDCH scheduling information of the PRDCH control information may include information on the chip period of the line code for the PRDCH. The PRDCH control information may include information on the chip period of the line code used for the PRDCH. Alternatively, the PRDCH control information may include a part of information on the chip period of the line code used for the PRDCH. The part of the information on the chip period of the line code used for the PRDCH may be indicated through the preamble. The device may determine information on the chip period of the line code used for the PRDCH based on the information of the preamble and the PRDCH control information. The preamble may include information on a base chip period of the line code. The PRDCH control information may include offset information (e.g., information on an offset relative to the base chip period). The device may determine the chip period of the line code used for PRDCH transmission by using the base chip period indicated by the preamble and the offset indicated by the PRDCH control information.

The PRDCH scheduling information of the PRDCH control information may include PRDCH repetition information. The PRDCH repetition information may indicate whether the PRDCH (e.g., PRDCH transmission) is repeated in the time domain. The PRDCH repetition information may indicate whether the PRDCH is repeated on a bit basis. Alternatively, the PRDCH repetition information may indicate whether the PRDCH is repeated on a block basis. A block may refer to a TB. Alternatively, the PRDCH repetition information may indicate whether the PRDCH is repeated on a chip basis. A chip may refer to an OOK modulation symbol, an OOK demodulation symbol, or a chip of the line code.

The PRDCH scheduling information of the PRDCH control information may include information on the number of TBs within the PRDCH. When the PRDCH includes two or more TBs, the PRDCH scheduling information may include information on a start time and an end time for each TB.

The PDRCH scheduling information of the PRDCH control information will be described. The PDRCH scheduling information may be scheduling information for a PDRCH transmission scheduled by the PRDCH. The PRDCH control information may include the PDRCH scheduling information. The device may receive the PRDCH from the reader, may identify the PDRCH scheduling information included in the PRDCH, and may perform the PDRCH transmission based on the PDRCH scheduling information. The PDRCH scheduling information may include one or more of the following information:
Modulation scheme (e.g., OOK or Binary Phase Shift Keying (BPSK))
Line code information (e.g., information indicating whether a line code is applied, a type of line code, or a chip period of the line code)
Forward Error Correction (FEC) information (e.g., code rate)
TB size
Frequency resource information
Time resource information
ID information
Repeated transmission information
Modulation and Coding Scheme (MCS) information
Midamble information

The modulation scheme may refer to a modulation scheme used for the PDRCH transmission. The modulation scheme may indicate the OOK scheme or the BPSK scheme. The line code information may include type information of the line code used for the PDRCH. The line code information may include a chip period of the line code used for the PDRCH transmission.

The FEC information may include information related to a channel code used for the PDRCH. The FEC information may include information indicating whether a channel code is applied to the PDRCH. The FEC information may include a code rate of the channel code used for the PDRCH. For example, the code rate indicated by the FEC information may be 1, 1/2, or 1/3. The code rate of 1 may indicate that no channel coding is applied. The channel code may be a convolutional code.

The TB size may refer to a size of a TB for the PDRCH transmission. The TB size may refer to the amount (e.g., size) of information bits transmitted through the PDRCH. Alternatively, the TB size may refer to a size of a payload transmitted through the PDRCH. The TB size may be indicated in bytes. The TB size may be indicated by bit information. A length of bit information indicating the TB size may be 7 bits.

The time resource information may include information on a time resource in which the PDRCH is transmitted. The time resource information may include length information (e.g., time duration information) of the PDRCH. The time resource information may include information on a transmission time of the PDRCH. The time resource information may be indicated in units of chip periods. Alternatively, the time resource information may be indicated in units of absolute time (e.g., microseconds (μs)).

The frequency resource information may include information on a frequency resource in which the PDRCH is transmitted. The ID information may indicate an ID of a device transmitting the PDRCH. The ID information may indicate an ID of a reader receiving the PDRCH. The repeated transmission information may include information indicating whether the PDRCH is repeatedly transmitted, the number of repeated transmissions of the PDRCH, a type of repeated transmission of the PDRCH, and/or a form of repeated transmission of the PDRCH. When the PDRCH is repeatedly transmitted, the repeated transmission information may include information on a type of repeated transmission of the PDRCH. The repeated transmission information may indicate whether the PDRCH is repeated on a bit basis. Alternatively, the repeated transmission information may indicate whether the PDRCH is repeated on a block basis. A block may refer to a TB. A block may be a block (e.g., bit(s)) generated by inserting CRC bits into information bits at a higher layer or physical layer. Alternatively, the repeated transmission information may indicate whether the PDRCH is repeated on a chip basis. A chip may refer to a modulation symbol, a demodulation symbol, or a chip of the line code. When the PDRCH is repeatedly transmitted, the repeated transmission may refer to repeated transmission within one PDRCH. The number of transmitted PDRCHs may not change depending on whether repeated transmission is applied.

The MCS information may include information on a modulation scheme and/or a code rate used for the PDRCH transmission. The midamble information may include information on a midamble used for the PDRCH transmission. The midamble information may include information indicating whether a midamble is included in the PDRCH (e.g., PDRCH transmission). The midamble information may include information on a time interval of midamble(s) used for the PDRCH transmission. The midamble information may include information on sequence(s) of midamble(s) used for the PDRCH transmission. The sequence information may include information on a length of a sequence.

The PDRCH scheduling information may include indication information of a chip period. The chip period may refer to a length of one modulation symbol in the time domain. For example, the chip period may be identical to the chip period in the exemplary embodiment of FIG. 6. Alternatively, the chip period may refer to a length of a unit time representing one amplitude. For example, the chip period may be identical to a time duration of a signal having a low amplitude (e.g., 0) or a signal having a high amplitude (e.g., 1) in the exemplary embodiment of FIG. 6. The chip period may be used in the same sense as a chip length.

The chip period of the PDRCH may be indicated through the PRDCH control information. The reader may transmit information on the chip period used for PDRCH transmission by using the PRDCH control information. The device may receive the PRDCH control information and may determine information on the chip period used for PDRCH transmission based on the PRDCH control information (e.g., PDRCH scheduling information). Values of chip periods available for the PDRCH transmission may be predefined. The reader may indicate one of the available predefined chip period values to the device through the PRDCH control information. The device may determine one chip period indicated by the reader from among the predefined available chip period values and may use the chip period indicated by the reader as the chip period for PDRCH transmission.

A length (e.g., time duration) of the chip period may be predefined, and the indication of the chip period may indicate the predefined value (e.g., the length). A number of bits transmitted in one OFDM symbol may be predefined, and the indication of the chip period may indicate the predefined value (e.g., number of bits). The device may determine one chip period based on a result of dividing the length of one OFDM symbol by the number of bits.

A time resource scheduling method for a PDRCH transmission will be described. A start time of the PDRCH transmission may be determined based on the PDRCH scheduling information included in the PRDCH. The reader may indicate information on a transmission time (e.g., a start time) of the PDRCH to the device through the PDRCH scheduling information within the PRDCH control information. The device may determine the information on the transmission time of the PDRCH based on the information indicated by the reader.

The information on the transmission time of the PDRCH may mean at least one of the start time of the PDRCH transmission or an end time of the PDRCH transmission. The start time of the PDRCH transmission may refer to a start time of the PDRCH or a start time of a D2R transmission including the PDRCH and a preamble located before the PDRCH. The end time of the PDRCH transmission may refer to an end time of the PDRCH or an end time of a D2R transmission including the PDRCH and a postamble located after the PDRCH. When the PDRCH transmission is possible at the PDRCH transmission time indicated by the reader, the device may perform the PDRCH transmission. When the PDRCH transmission is not possible at the PDRCH transmission time indicated by the reader, the device may not perform the PDRCH transmission.

The information on the transmission time of the PDRCH may be indicated by a time offset from the end time of the PRDCH including the PDRCH scheduling information to the start time of the PDRCH transmission. The end time of the PRDCH transmission may be an end time of the PRDCH payload. Alternatively, the end time of the PRDCH transmission may be an end time of padding bits after the PRDCH payload. Alternatively, the end time of the PRDCH transmission may be an end time of a signal (e.g., postamble) that allows determination of the end of the PRDCH transmission.

A time unit indicating the PDRCH transmission time may be a time unit of the PRDCH transmission including the PDRCH scheduling information. The PDRCH transmission time may be indicated by using a time unit used for the PRDCH transmission (e.g., a length of a modulation symbol, a chip period of the line code). Alternatively, the time unit indicating the PDRCH transmission time may be a time unit used for the PDRCH transmission. The PDRCH transmission time may be indicated by using a time unit used for the PDRCH transmission (e.g., a length of a modulation symbol, a chip period of a line code).

The time unit indicating the PDRCH transmission time may be indicated based on a minimum time unit supported by the system. The PDRCH transmission time may be indicated by using a minimum length of a modulation symbol and/or a minimum chip period of the line code used for the PRDCH transmission or the PDRCH transmission. The minimum length of a modulation symbol and/or the minimum chip period of the line code may vary depending on the value of M supported for the OOK modulation scheme. The minimum time unit may be derived based on a length of a modulation symbol and/or a chip period of a line code according to a maximum value of M supported for the OOK-4 (M) modulation scheme.

The time unit indicating the PDRCH transmission time may be indicated based on a length of the PRDCH or a length of the PDRCH. The PDRCH transmission time may be indicated in a time length unit of the PRDCH scheduling the PDRCH. The PDRCH transmission time may be indicated in a time length unit of the PDRCH scheduled by the PRDCH.

The time unit indicating the PDRCH transmission time may be indicated based on a length of an OFDM symbol in the communication system (e.g., NR communication system). In other words, the PDRCH transmission time may be indicated in a unit of a length of an OFDM symbol in the communication system (e.g., NR communication system).

The PDRCH may be transmitted by using backscattering through impedance matching for a signal received by the device depending on a form of the device. The PDRCH may be transmitted by the device itself generating a signal depending on a form of the device. To supply power necessary for signal transmission and/or signal reception, the device may use an energy harvesting scheme of charging energy from a radio frequency (RF) signal.

In a communication network, a device may perform a PDRCH transmission. In the communication network, a reader may receive the PDRCH transmitted by the device. The reader may perform a PRDCH transmission associated with the PDRCH received from the device. The device may receive a PRDCH associated with the PDRCH transmitted by the device from the reader.

The reader may perform the PRDCH transmission within a predefined time duration. The reader may not perform the PRDCH transmission outside the predefined time duration. The device may perform signal monitoring to receive the PRDCH. The device may perform PRDCH monitoring (e.g., PRDCH signal monitoring) within the predefined time duration. The device may not perform the PRDCH signal monitoring outside the predefined time duration.

For convenience of description, the predefined time duration may be referred to as a PRDCH reception window. The PRDCH may be transmitted and received within the PRDCH reception window. The PRDCH transmission operation of the reader may start within the PRDCH reception window. The start time and/or end time of the PRDCH transmission of the reader may fall within the PRDCH reception window. The device may receive the PRDCH within the PRDCH reception window. The reception operation of the PRDCH by the device may start within the PRDCH reception window. The start time and/or end time of the PRDCH reception by the device may fall within the PRDCH reception window.

The PRDCH reception window may be defined by a start time and an end time. Alternatively, the PRDCH reception window may be defined by a start time and a length. The start time of the PRDCH reception window may be defined based on a time offset from the end time of the PDRCH transmission. The end time of the PRDCH reception window may be defined based on a time offset from the end time of the PDRCH transmission. The end time of the PRDCH reception window may be defined based on a time offset from the start time of the PRDCH reception window.

Information on the PRDCH reception window (e.g., the time offset from the end time of the PDRCH transmission (e.g., time offset value) and/or the length of the PRDCH reception window) may be predefined. The device may identify the end time of the PDRCH transmission through the PDRCH transmission. The device may identify the information on the predefined PRDCH reception window. The device may identify the PRDCH reception window (e.g., a duration of the PRDCH reception window) based on the end time of the PDRCH transmission and the information of the predefined PRDCH reception window.

A part of the information on the PRDCH reception window may be predefined. For example, the time offset (e.g., time offset value) for indicating the start time of the PRDCH reception window may be predefined. The reader may indicate the part of the information on the PRDCH reception window to the device through signaling. For example, the reader may transmit, through signaling, the time offset for indicating the end time of the PRDCH reception window and/or the length of the PRDCH reception window to the device. The reader may transmit the PRDCH including information for indicating the end time of the PRDCH reception window to the device. The PRDCH including information for indicating the end time of the PRDCH reception window may be a PRDCH transmitted before the PRDCH reception window. The PRDCH (e.g., first PRDCH) including the information for indicating the end time of the PRDCH reception window may be different from another PRDCH (e.g., second PRDCH) that is transmitted within the PRDCH reception window indicated by the first PRDCH. The device may receive the PRDCH and may identify the end time of the PRDCH reception window based on the information included in the PRDCH. The device may identify the PRDCH reception window (e.g., the duration of the PRDCH reception window) based on the information of the predefined PRDCH reception window (e.g., partial information) and the information received from the reader (e.g., the end time of the PRDCH reception window).

According to another exemplary embodiment, the reader may transmit the information on the PRDCH reception window to the device through signaling. The device may receive the information on the PRDCH reception window through signaling from the reader. For example, the reader may transmit the PRDCH including the information on the PRDCH reception window to the device. The PRDCH including the information on the PRDCH reception window may be transmitted before the PRDCH reception window. The PRDCH (e.g., first PRDCH) including the information on the PRDCH reception window may be different from another PRDCH (e.g., second PRDCH) that is transmitted within the PRDCH reception window indicated by the first PRDCH. The device may receive the information on the PRDCH reception window from the reader and may identify the PRDCH reception window (e.g., the duration of the PRDCH reception window) based on the received information.

The PRDCH reception window may be indicated using a time unit used for the PDRCH transmission. For example, the PRDCH reception window may be indicated based on the length of the OOK symbol or the chip period of the line code used for the PDRCH transmission. The PRDCH reception window may be indicated using a time unit used for the PRDCH transmission that schedules the PDRCH corresponding to the PRDCH reception window. For example, the PRDCH reception window may be indicated based on the length of the OOK symbol or the chip period of the line code used for the PRDCH transmission that schedules the PDRCH corresponding to the PRDCH reception window.

The device may perform PRDCH signal monitoring within the PRDCH reception window. The device may receive a PRDCH signal within the PRDCH reception window. The device may not perform PRDCH signal monitoring during a time duration outside the PRDCH reception window. The device may not receive a PRDCH signal during a time duration outside the PRDCH reception window.

The device may perform PRDCH signal monitoring from the start time of the PRDCH reception window. The device may perform PRDCH signal monitoring until the end time of the PRDCH reception window. When a PRDCH signal is not received until the end time of the PRDCH reception window, the device may terminate the PRDCH signal monitoring. When a PRDCH is not received within the PRDCH reception window, the device may not perform PRDCH signal monitoring during a time duration after the PRDCH reception window.

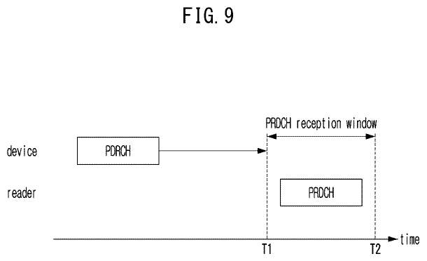

FIG. 9 is a conceptual diagram illustrating a PRDCH reception method in a communication network.

Referring to FIG. 9, a device may perform a PDRCH transmission. The device may identify a PRDCH reception window using an end time of the PDRCH transmission and information on the PRDCH reception window. The reader may transmit a PRDCH within the PRDCH reception window. The device may perform PRDCH signal monitoring within the PRDCH reception window. The device may receive the PRDCH within the PRDCH reception window.

The device may perform a PDRCH transmission. The reader may receive a PDRCH from the device and may transmit a PRDCH corresponding to the PDRCH. The device may perform signal monitoring for PRDCH reception. The device may perform PRDCH signal monitoring after a time offset from a transmission time of the PDRCH. The device may not perform PRDCH signal monitoring before a time offset from the transmission time of the PDRCH. The reader may perform a PRDCH transmission after a time offset from a reception time of the PDRCH. The reader may not perform a PRDCH transmission before the time offset from the reception time of the PDRCH.

The time offset may be defined as a minimum time offset from the end time of the PDRCH transmission to a start time of the PRDCH transmission. The end time of the PDRCH transmission may indicate a transmission end time of the PDRCH (e.g., PDRCH signal). Alternatively, the end time of the PDRCH transmission may indicate a transmission end time of a D2R signal including the PDRCH and a signal (e.g., midamble or postamble) following the PDRCH. The start time of the PRDCH transmission may indicate a transmission start time of the PRDCH (e.g., PRDCH signal). Alternatively, the start time of the PRDCH transmission may indicate a transmission start time of an R2D signal including the PRDCH and a signal (e.g., preamble) preceding the PRDCH.

The time offset may be a predefined value. Alternatively, the time offset may be a value configured by the system (e.g., communication system). For example, the reader may indicate the time offset to the device through signaling. The device may receive the time offset through signaling from the reader. The time offset may be indicated using a time unit used for the PDRCH transmission. Alternatively, the time offset may be indicated using a time unit used for the PRDCH transmission.

The reader may add CRC (e.g., CRC field or CRC bits) into the PRDCH. For example, the reader may apply one CRC (e.g., one CRC encoding) to control information and a payload in the PRDCH. In another example, the reader may apply one CRC (e.g., one CRC encoding) to the control information in the PRDCH, and may apply another CRC (e.g., another CRC encoding) to the payload in the PRDCH. In other words, CRC checking for the control information and the payload in the PRDCH may be performed independently. In the addition of CRC bits for the PRDCH, different CRC bits may be added into the PRDCH depending on a time length or bit length of the PRDCH. For example, based on whether the length of the PRDCH exceeds a threshold, a different length of CRC bits may be added into the PRDCH. CRC bits having a long length may be added into a PRDCH having a long length. CRC bits having a short length may be added into a PRDCH having a short length. For example, when the length (e.g., information length) of the PRDCH is equal to or less than X bits, a CRC composed of A bits may be applied to the PRDCH. When the length of the PRDCH exceeds X bits, a CRC composed of B bits may be applied to the PRDCH. Each of X, A, and B may be a natural number. For example, X may be 24, A may be 6, and B may be 16.

According to another exemplary embodiment, whether to add CRC bits may be determined based on whether the length (e.g., information length) of the PRDCH exceeds a threshold. When the length of the PRDCH is equal to or less than Y bits, CRC bits may not be added into the PRDCH. When the length of the PRDCH exceeds Y bits, CRC bits may be added into the PRDCH. According to another exemplary embodiment, whether to add CRC bits may be determined based on a type of a message transmitted through the PRDCH.

When the device successfully receives the PRDCH, the device may transmit ACK information for the PRDCH to the reader. The device may determine whether the PRDCH has been successfully received based on CRC checking (e.g., CRC verification) for the PRDCH. When the device fails to successfully receive the PRDCH, the device may transmit NACK information for the PRDCH to the reader. The device may transmit HARQ information (e.g., ACK information or NACK information) to the reader using a physical layer message. Alternatively, the device may transmit HARQ information (e.g., ACK information or NACK information) to the reader using a higher layer message (e.g., MAC CE).

The postamble for R2D transmission will be described. Referring again to FIG. 8, the reader may transmit the postamble after the PRDCH transmission. The postamble may be transmitted in the time domain after the PRDCH. The postamble may be configured as a signal of a predefined form. The postamble may be configured as a different form of signal depending on an implementation of the reader. When the device detects the postamble, the device may determine that the PRDCH transmission has ended. The device may determine an end time of the PRDCH transmission based on the detection of the postamble. The device may determine a time length of the PRDCH transmission based on the detection of the postamble.

The device may determine the end time of the PRDCH transmission by identifying the postamble or PRDCH control information. When the PRDCH control information includes information related to the end time (e.g., transmission end time point) of the PRDCH, the device may determine the end time of the PRDCH using the information. Alternatively, when the PRDCH control information includes information related to the end time (e.g., transmission end time) of the PRDCH, the device may determine the end time of the PRDCH using the information and/or the postamble. When the PRDCH control information does not include information related to the end time (e.g., transmission end time) of the PRDCH, the device may determine the end time of the PRDCH using the postamble.

The configuration of the postamble will be described. The postamble may be predefined in the system (e.g., communication system), and the postamble may be a form of signal already known to the device. The postamble may be a signal that differs depending on an implementation of the reader. The postamble may be configured in a form different from a code 0 or code 1 of a line code used for the preamble or the PRDCH. The postamble may be a form of signal that cannot be defined by the line code. The postamble may be a form of signal that cannot occur when using a Manchester code as the line code. The postamble may be configured as a form of signal having an amplitude of at least a certain magnitude during a certain time duration. The amplitude magnitude of the postamble may be 1. Alternatively, the postamble may be configured as a form of signal having an amplitude of at most a certain magnitude during a certain time duration. The amplitude magnitude of the postamble may be 0.

The length of the time duration of the postamble may be equal to or greater than one chip period of the line code used for the preamble or the PRDCH. The length of the time duration of the postamble may be variably configured according to the chip period of the line code used for the preamble or the PRDCH. The length of the time duration of the postamble may be configured as a multiple of the chip period of the line code used for the preamble or the PRDCH.

When the device receives the postamble, the device may determine that the PRDCH transmission (e.g., the PRDCH transmission associated with the postamble) has ended. The device may determine that a signal received before the postamble corresponds to the PRDCH and may perform payload decoding for the PRDCH. The device may detect a type of signal that cannot occur when using the line code such as Manchester code during PRDCH reception (hereinafter referred to as an ‘abnormal signal’). When the abnormal signal is detected, the device may determine that the PRDCH transmission (e.g., the PRDCH transmission associated with the abnormal signal) has ended. The device may determine that a signal received before the abnormal signal corresponds to the PRDCH and may perform payload decoding for the PRDCH. For example, when the abnormal signal is detected at the N-th chip, the device may determine that the PRDCH has been received up to the (N−1)-th chip. Alternatively, when the abnormal signal is detected at the N-th chip, the device may determine that the PRDCH has been received up to the (N−2)-th chip. N may be a natural number. When the PRDCH reception is completed, the device may operate in a sleep mode. The device operating in the sleep mode may perform energy harvesting operations.

The device may identify a start of the PRDCH transmission through the preamble and may operate (e.g., initiate) a timer for PRDCH reception based on the identified preamble. When the postamble is detected, the device may stop the timer and may stop the PRDCH reception. When the timer expires without detection of the postamble, the device may stop the PRDCH reception from an expiration time of the timer. When the device stops the PRDCH reception, the device may operate in the sleep mode.

Transmission schemes of the PRDCH will be described. The reader may transmit the PRDCH using an OFDM scheme or a Discrete Fourier Transform-spread-Orthogonal Frequency Division Multiplexing (DFT-s-OFDM) scheme. A subcarrier spacing of the PRDCH may be 15 kHz.

A transmission bandwidth of the PRDCH will be described. In a communication system (e.g., 4G communication system, 5G communication system, or 6G communication system) using a 15 kHz subcarrier spacing, a minimum transmission bandwidth of the PRDCH may be equal to a bandwidth of one PRB, which is 180 kHz. The transmission bandwidth of the PRDCH may be configured as a multiple of 180 kHz. In other words, the transmission bandwidth of the PRDCH may be extended in units of PRBs in the communication system (e.g., 4G communication system, 5G communication system, or 6G communication system).

A transmission band of the PRDCH will be described. The PRDCH may be transmitted using one of the following three bands: a band identical to that of the NR/LTE communication system, a guard band of the NR/LTE communication system, or an independent band.

When the PRDCH transmission is performed using the same band as the NR/LTE communication system or using the guard band of the NR/LTE communication system, a start time of the PRDCH transmission in the time domain may be configured to be identical to a start time of an OFDM symbol of the communication system (e.g., LTE communication system or NR communication system) using a 15 kHz subcarrier spacing. The start time of the PRDCH transmission may indicate a start time of an R2D signal including the PRDCH and a preamble preceding the PRDCH.

A plurality of PRDCH transmissions may be multiplexed in the time domain. As in the exemplary embodiment of FIG. 5, one PRDCH transmission may be a transmission of ‘preamble+PRDCH’, a transmission of ‘PRDCH+postamble’, or a transmission of ‘preamble+PRDCH+postamble’. The plurality of PRDCH transmissions may be performed sequentially in the time domain. A time interval between continuous PRDCH transmissions may be predefined. For example, when two PRDCH transmissions are sequentially performed, a time interval between the two PRDCH transmissions may be predefined in the communication system. The time interval (e.g., actual time interval) between the two PRDCH transmissions may be equal to or greater than a predefined time interval. The time interval may refer to a time interval from an end time of the first PRDCH transmission to a start time of the second PRDCH transmission. The end time of the first PRDCH transmission may indicate an end time of the PRDCH or an end time point of the postamble in the exemplary embodiment of FIG. 5. The start time of the second PRDCH transmission may indicate a start time of the PRDCH or a start time of the preamble in the exemplary embodiment of FIG. 5.

A plurality of PDRCH transmissions may be multiplexed in the time domain. The plurality of PDRCH transmissions may be sequentially performed in the time domain. A time interval between continuous PDRCH transmissions may be predefined. For example, when two PDRCH transmissions are sequentially performed, a time interval between the two PDRCH transmissions may be predefined in the communication system. The time interval (e.g., actual time interval) between the two PDRCH transmissions may be equal to or greater than a predefined time interval.

The time interval may indicate a time interval from a start time of the first PDRCH transmission to a start time of the second PDRCH transmission. The start time of the first PDRCH transmission may be a start time of a PDRCH. Alternatively, the start time of the first PDRCH transmission may be a start time of a D2R transmission including the PDRCH and a signal (e.g., preamble) preceding the PDRCH. The start time of the second PDRCH transmission may be a start time of a PDRCH. Alternatively, the start time of the second PDRCH transmission may be a start time of a D2R transmission including the PDRCH and a signal (e.g., preamble) preceding the PDRCH.

According to another exemplary embodiment, the time interval may indicate a time interval from an end time of the first PDRCH transmission to a start time of the second PDRCH transmission. The end time of the first PDRCH transmission may be an end time of the PDRCH. Alternatively, the end time of the first PDRCH transmission may be an end time of a D2R transmission including the PDRCH and a signal (e.g., midamble or postamble) following the PDRCH. The start time of the second PDRCH transmission may be a start time of the PDRCH. Alternatively, the start time of the second PDRCH transmission may be a start time of a D2R transmission including the PDRCH and a signal (e.g., preamble) preceding the PDRCH.

A wake-up mode or a sleep mode of a device in the communication network may be considered. A device in the wake-up mode may transmit and receive signals. A device in the sleep mode may not transmit or receive signals.

A device may determine an operation mode (e.g., wake-up mode or sleep mode) based on a remaining battery level of a battery mounted in the device. When the device has a remaining battery level sufficient to perform a reception operation and/or a transmission operation, the device may operate in the wake-up mode. When a magnitude of a signal received by the device is greater than an activation threshold of the device, the device may operate in the wake-up mode.

When the above-described condition(s) are satisfied, the device may operate in the wake-up mode. The device in the wake-up mode may perform R2D signal monitoring until a remaining battery level of the device reaches a level at which a reception operation and/or a transmission operation cannot be performed. The level at which a reception operation and/or a transmission operation cannot be performed may indicate battery depletion. When the remaining battery level of the device reaches the level at which a reception operation and/or a transmission operation cannot be performed, the device may operate in the sleep mode. In other words, the operation mode of the device may transition from the wake-up mode to the sleep mode. The device operating in the sleep mode may perform an energy harvesting operation. The device may charge the battery through the energy harvesting operation.

The device operating in the wake-up mode may perform R2D signal monitoring until a magnitude of a received signal becomes smaller than the activation threshold of the device. When the magnitude of the signal received by the device becomes smaller than the activation threshold of the device, the device may operate in the sleep mode. In other words, the operation mode of the device may transition from the wake-up mode to the sleep mode. The device operating in the sleep mode may perform the energy harvesting operation. The device may charge the battery through the energy harvesting operation.

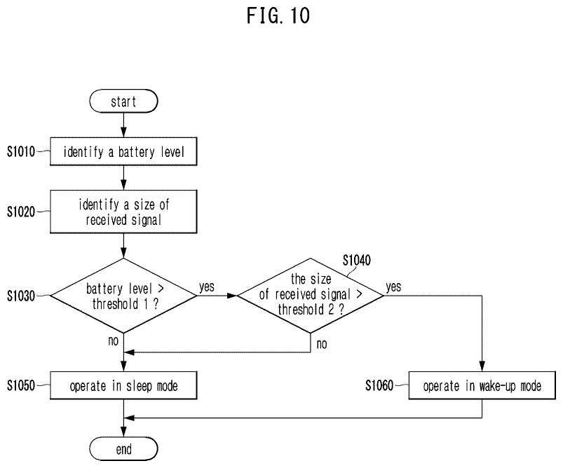

FIG. 10 is a flowchart illustrating a method of operation of a device in a communication network.

Referring to FIG. 10, a device may identify a remaining battery level of the device (S1010). The device may receive a signal and may identify a magnitude of the received signal (S1020). The device may compare the remaining battery level of the device with a first threshold (S1030). When the remaining battery level of the device is less than or equal to the first threshold, the device may operate in the sleep mode (S1050). When the remaining battery level of the device is greater than the first threshold, the device may compare the magnitude of the received signal with a second threshold (S1040). When the magnitude of the received signal is less than or equal to the second threshold, the device may operate in the sleep mode (S1050). When the magnitude of the received signal is greater than the second threshold, the device may operate in the wake-up mode (S1060). In other words, when the remaining battery level of the device is greater than the first threshold and the magnitude of the received signal is greater than the second threshold, the device may operate in the wake-up mode (S1060).

According to another exemplary embodiment, the device may determine an operation mode based on a timer. The device in the wake-up mode may initiate the timer. When no signal is received before the timer expires, the device may operate in the sleep mode.

When the remaining battery level of the device is equal to or greater than a battery threshold, the device may operate in the wake-up mode. When the magnitude of the signal received by the device is greater than an activation threshold of the device, the device may operate in the wake-up mode.

When the device starts to operate in the wake-up mode, the device may initiate (e.g., start) a timer. The device may operate in the wake-up mode until the timer expires. The device in the wake-up mode may perform a transmission and reception operation of signals. When the device fails to receive an R2D signal while operating in the wake-up mode, the device may operate in the sleep mode. The R2D signal may be a signal designated to be received by the device.

When the device receives the R2D signal while operating in the wake-up mode, the device may reset the timer. The device may determine an operation mode (e.g., wake-up mode or sleep mode) based on the timer that is reset after the reception of the R2D signal or transmission of a D2R signal.

According to another exemplary embodiment, when the device receives the R2D signal while operating in the wake-up mode, the device may operate in the sleep mode after the reception of the R2D signal or transmission of a D2R signal. The device in the sleep mode may perform an energy harvesting operation. The device in the sleep mode may charge the battery by performing the energy harvesting operation. When the charged battery level is equal to or greater than a threshold, the device may operate in the wake-up mode.

According to another exemplary embodiment, the device may determine an operation mode (e.g., wake-up mode or sleep mode) based on information received from the reader. The reader may transmit at least one of wake-up mode information or sleep mode information to the device through signaling (e.g., R2D transmission and/or PRDCH transmission). The wake-up mode information may include information indicating a time duration during which the device operates in the wake-up mode. The sleep mode information may include information indicating a time duration during which the device operates in the sleep mode. The device may receive the wake-up mode information and/or the sleep mode information through signaling from the reader. The device may operate in the wake-up mode or the sleep mode based on the information (e.g., the wake-up mode information and/or the sleep mode information) received from the reader.

The reader may transmit the wake-up mode information to the device through signaling, and the device may receive the wake-up mode information through signaling from the reader. The device may operate in the wake-up mode during the time duration indicated by the wake-up mode information. The device may operate in the sleep mode during the time duration not indicated by the wake-up mode information.

The reader may transmit the sleep mode information to the device through signaling, and the device may receive the sleep mode information through signaling from the reader. The device may operate in the sleep mode during the time duration indicated by the sleep mode information. The device may operate in the wake-up mode during a time duration not indicated by the sleep mode information.

The reader may transmit a signal for time synchronization of the device. For example, the reader may perform transmission of periodic signals for the purpose of time synchronization with the device. The device may acquire time synchronization based on reception of the periodic signals. The device may identify reference time information for the time duration of the wake-up mode and/or the time duration of the sleep mode based on the reception of the periodic signals.

The reader may transmit a signal including information on another signal transmission duration to the device. For example, an R2D signal transmitted by the reader to the device may include information on a transmission duration of a next R2D signal after the transmission of the R2D signal. The device may identify information on the transmission duration of the next R2D signal based on the information received from the reader. The device may operate in the sleep mode during a duration from a reception end time of the current R2D signal to a reception start time of the next R2D signal based on the information received from the reader. Alternatively, the device may operate in the sleep mode during a duration from a transmission end time of a D2R signal corresponding to the current R2D signal to the reception start time of the next R2D signal based on the information received from the reader.

The device may transmit energy state information of the device to the reader. The reader may receive the energy state information of the device from the device. The energy state information may include information indicating whether the device holds a sufficient level of energy to complete a communication procedure requested by the reader.

For example, the reader may instruct the device to perform a random access procedure. The device may transmit energy state information including information indicating whether the device holds sufficient energy to perform the random access procedure to the reader. According to another exemplary embodiment, the energy state information may include information indicating whether the device can normally complete a communication procedure requested by the reader. A size of the energy state information (e.g., information included in the energy state information) may be 1 bit.

A method of resource allocation for signal transmission or signal reception of a device in a communication network in which a base station, a terminal, and the device exist will be described. The base station may perform time resource allocation and/or frequency resource allocation for signal transmission or signal reception of the device. The base station may transmit resource allocation information to the terminal (or, the device) through a higher layer message (e.g., RRC configuration or RRC message). The resource allocation information may include time resource allocation information and/or frequency resource allocation information. Alternatively, the base station may transmit the resource allocation information to the terminal (or, the device) through a physical layer message or a MAC layer message. The physical layer message may be a DCI. The MAC layer message may be a MAC CE.

Alternatively, the base station may transmit the resource allocation information to the terminal (or the device) through a combination of a higher layer message and a physical layer message or a combination of a higher layer message and a MAC layer message. For example, the base station may transmit the resource allocation information to the terminal (or the device) through a higher layer message, and may transmit information for indicating activation or deactivation of a resource indicated by the resource allocation information to the terminal (or the device) through a physical layer message or a MAC layer message. The activation of the resource may indicate that the resource is used for an IoT purpose. The deactivation of the resource may indicate that the resource is not used for an IoT purpose.

The terminal may transmit a signal to the device using the resource indicated by the base station. Alternatively, the terminal may receive a signal from the device using the resource indicated by the base station. The terminal may not transmit or receive a signal with the device using a resource (e.g., time resource and/or frequency resource) other than the resource indicated by the base station. The terminal may not transmit or receive a signal with the base station using a resource (e.g., time resource and/or frequency resource) other than the resource indicated by the base station.

The reader may perform proximity determination to determine whether the device is located in a region proximal to the reader. For example, the reader may transmit a signal and may receive a response (e.g., response signal) to the signal from the device. When a response to the signal transmitted by the reader is normally received from the device, the reader may determine that the device is located in a region proximal to the reader. In another example, the reader may transmit a PRDCH and may receive a PDRCH corresponding to the PRDCH from the device. When the PDRCH corresponding to the PRDCH transmitted by the reader is normally received from the device, the reader may determine that the device is located in a region proximal to the reader.

According to another exemplary embodiment, the reader may measure a magnitude of a signal received from the device and may determine whether the device is located in a region proximal to the reader based on the measured magnitude. The device may transmit a signal to the reader, and the reader may receive the signal from the device and may measure a magnitude of the received signal. The reader may determine whether the device is located in a region proximal to the reader based on the measured magnitude. For example, when the measured magnitude is equal to or greater than a threshold, the reader may determine that the device is located in a region proximal to the reader.

According to another exemplary embodiment, the reader may transmit a signal to the device and may receive a response (e.g., response signal) to the signal from the device. When the response to the signal transmitted by the reader is normally received from the device, the reader may measure a magnitude of the response received from the device and may determine whether the device is located in a region proximal to the reader based on the measured magnitude. For example, the reader may transmit a PRDCH to the device and may receive a PDRCH corresponding to the PRDCH from the device. When the PDRCH corresponding to the PRDCH transmitted by the reader is normally received from the device, the reader may measure a magnitude of the PDRCH received from the device and may determine whether the device is located in a region proximal to the reader based on the measured magnitude. For example, when the measured magnitude of the PDRCH received from the device is equal to or greater than a threshold, the reader may determine that the device is located in a region proximal to the reader.

A magnitude of a signal received at the reader may vary depending on a transmission signal strength of the device. For the proximity determination of the device by the reader, the device may transmit transmission signal information to the reader through signaling. The reader may receive the transmission signal information through signaling from the device. The transmission signal information of the device may include at least one of a magnitude of a transmission signal, a transmission amplifier output, or a magnitude of a signal received for backscatter transmission. The reader may determine whether the device is located in a region proximal to the reader based on the transmission signal information received from the device.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a reader, comprising:
generating a physical reader-to-device channel (PRDCH) preamble including a first preamble and a second preamble;
generating a reader-to-device (R2D) signal including the PRDCH preamble and a PRDCH; and
transmitting the R2D signal to a device,
wherein the PRDCH preamble is located before the PRDCH in time domain.

2. The method according to claim 1, wherein the first preamble is used to indicate a transmission start of the PRDCH, and a length of the first preamble has a fixed value in time domain.

3. The method according to claim 1, wherein the second preamble is used to acquire synchronization for receiving the PRDCH, and a length of the second preamble in time domain is changed based on M of an on-off keying (OOK) modulation scheme used for the PRDCH, and M is a number of coded bits per orthogonal frequency division multiplexing (OFDM) symbol.

4. The method according to claim 1, wherein a chip period of the second preamble is equal to a chip period of the PRDCH.

5. The method according to claim 1, wherein the PRDCH includes control information and a payload, and the control information includes at least one of PRDCH scheduling information or physical device-to-reader channel (PDRCH) scheduling information.

6. The method according to claim 5, wherein a part of the PRDCH scheduling information is transmitted using a physical layer message.

7. The method according to claim 5, wherein a part of the PDRCH scheduling information is transmitted using a higher layer message.

8. The method according to claim 5, wherein a cyclic redundancy check (CRC) is applied independently for each of the control information and the payload.

9. A method of a device, comprising:
receiving a reader-to-device (R2D) signal from a reader,
wherein the R2D signal includes a physical reader-to-device channel (PRDCH) preamble and a PRDCH, the PRDCH preamble includes a first preamble and a second preamble, and the PRDCH preamble is located before the PRDCH in time domain.

10. The method according to claim 9, wherein the receiving of the R2D signal from the reader comprises: determining a start time of the PRDCH based on the first preamble included in the R2D signal, wherein a length of the first preamble has a fixed value in time domain.

11. The method according to claim 9, wherein the receiving of the R2D signal from the reader comprises: acquiring synchronization for receiving the PRDCH based on the second preamble included in the R2D signal, wherein a length of the second preamble in time domain is changed based on M of an on-off keying (OOK) modulation scheme used for the PRDCH, and M is a number of coded bits per orthogonal frequency division multiplexing (OFDM) symbol.

12. The method according to claim 9, wherein a chip period of the second preamble is equal to a chip period of the PRDCH.

13. The method according to claim 9, wherein the PRDCH includes control information and a payload, and the control information includes at least one of PRDCH scheduling information or physical device-to-reader channel (PDRCH) scheduling information.

14. The method according to claim 13, wherein a part of the PRDCH scheduling information is received using a physical layer message.

15. The method according to claim 13, wherein a part of the PDRCH scheduling information is received using a higher layer message.

16. The method according to claim 13, wherein a cyclic redundancy check (CRC) is applied independently for each of the control information and the payload.

17. A device comprising at least one processor, wherein the at least one processor causes the device to perform: receiving a reader-to-device (R2D) signal from a reader,
wherein the R2D signal includes a physical reader-to-device channel (PRDCH) preamble and a PRDCH, the PRDCH preamble includes a first preamble and a second preamble, and the PRDCH preamble is located before the PRDCH in time domain.

18. The device according to claim 17, wherein in the receiving of the R2D signal from the reader, the at least one processor causes the device to perform: determining a start time of the PRDCH based on the first preamble included in the R2D signal, wherein a length of the first preamble has a fixed value in time domain.

19. The device according to claim 17, wherein in the receiving of the R2D signal from the reader, the at least one processor causes the device to perform: acquiring synchronization for receiving the PRDCH based on the second preamble included in the R2D signal, wherein a length of the second preamble in time domain is changed based on M of an on-off keying (OOK) modulation scheme used for the PRDCH, and M is a number of coded bits per orthogonal frequency division multiplexing (OFDM) symbol.

20. The device according to claim 17, wherein the PRDCH includes control information and a payload, and the control information includes at least one of PRDCH scheduling information or physical device-to-reader channel (PDRCH) scheduling information.
